(19) United States
(12) Patent Application Publication
(10) Pub. No.: US 2009/0030743 A1
(43) Pub. Date: Jan. 29, 2009

(54) Intelligent Hotel Reservation System and Method

(75) Inventor: Kevin Alan Tussy, Las Vegas, NV (US)

Correspondence Address: BARNES & THORNBURG LLP, 600 ONE SUMMIT SQUARE, FORT WAYNE, IN, 46802, US

(73) Assignee: LAS VEGAS CENTRAL RESERVATION CORP., Las Vegas, NV (US)

(21) Appl. No.: 11/837,088

(22) Filed: Aug. 10, 2007

Related U.S. Application Data
(60) Provisional application No. 60/951,542, filed on Jul. 24, 2007.

(51) Int. Cl. G06Q 99/00; G06F 17/30

(52) U.S. Cl. 705/5

(57) ABSTRACT

A computerized system and method for making a hotel reservation. In some embodiments there are post-reservation features, such as the ability to continue searching for better prices after a room has been booked.

### RELATED APPLICATION

This application claims priority to U.S. Provisional Application Ser. No. 60/951,542, filed on Jul. 24, 2007, the entire disclosure of which is hereby incorporated by reference.

### TECHNICAL FIELD

This invention generally relates to a computerized travel reservation system. More particularly, the invention relates to a computerized hotel reservation system having post-reservation features, including the ability to continue searching for better prices after a room has been booked.

### BACKGROUND

Computerized hotel reservation systems are known. For example, a computerized reservation system known as the global distribution system (“GDS”) has been used for years by travel agents to book rooms at major hotel chains. More recently, travel-related websites have been launched that allow customers to search and book hotel rooms over the Internet.

Whether a travel agent or individual customer books the room, there is a risk that the rate may be reduced prior to the arrival date because of the fluctuation in hotel rates. Some websites have attempted to resolve this price fluctuation issue by offering customers the benefit of a lower price if the customer comes forward with a lower rate within a certain time period after the booking. However, this type of guarantee puts the burden on the customer to come forward with a lower price. Unless the customer continues to perform searches for a lower price after booking, there is no way to take advantage of the guarantee.

### SUMMARY

According to one aspect, the invention is a method for booking a hotel reservation. In one example embodiment, the method includes the step of providing a reservation database with a plurality of hotel reservations that each have a booked price. The plurality of hotel reservations is reviewed to determine whether a post-reservation price is available that is lower than the booked price. If so, the hotel reservation is rebooked at the post-reservation price. In some cases, this may mean that the existing reservation is cancelled in lieu of the new reservation at the post-reservation price. In other cases, the existing reservation may be edited to reflect the post-reservation price. Embodiments are contemplated in which the person associated with the rebooked reservation is notified about the savings received through the rebooking. In some embodiments, certain reservations are no longer reviewed for a lower post-reservation price when a penalty would be incurred if the reservation were rebooked, or only those prices where the savings would be greater than the penalty incurred.

In another embodiment, the method includes the step of receiving a request for pricing and availability of one or more hotels for one or more nights from a remote terminal. At least one hotel pricing data source is queried with the request. The search results are presented to the remote terminal, which may select a particular hotel reservation from the search results. The requested reservation is then booked at a booked price and typically a confirmation is received regarding the booking. After this occurs in this embodiment, a post-reservation price for the booked hotel reservation is periodically searched. If the post-reservation price is lower than the booked price, the reservation is rebooked at the post-reservation price. In some cases, a person associated with the reservation may be notified about the rebooking.

In another embodiment, the method includes the step of periodically checking a post-reservation price of a hotel reservation that was booked at a booked price. The post-reservation price is compared with the booked price. If the post-reservation price is lower than the booked price, the hotel reservation is rebooked at the post-reservation price.

According to another aspect, the invention provides a computer-readable medium having computer-executable instructions for performing a method, which includes the steps of periodically checking a post-reservation price of a hotel reservation that was booked at a booked price, comparing the post-reservation price with the booked price, and rebooking the hotel reservation at the post-reservation price if the post-reservation price is lower than the booked price.

According to a further aspect, the invention provides a computerized hotel reservation system. In this embodiment, the system includes means for periodically checking a post-reservation price of a hotel reservation that was booked at a booked price. Means for comparing the post-reservation price with the booked price may be included in the system. Additionally, means for rebooking the hotel reservation at the post-reservation price, if the post-reservation price is lower than the booked price, could also be provided.

In another embodiment, the system may include a search module configured to provide search results from a hotel pricing data source. A booking module configured to book a hotel reservation at a booked price selected from the search results provided by the search module may be provided. The system may include a rate reducer agent configured to periodically determine whether a post-reservation price for the hotel reservation is lower than the booked price and rebook the hotel reservation at the post-reservation price if the post-reservation price is lower than the booked price.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a block diagram showing an example environment for use of the intelligent hotel reservation system;

FIG. 2 is a block diagram showing an example embodiment of the rate reducer agent;

FIG. 3 is a flowchart showing example steps that may be performed by the intelligent hotel reservation system during operation;

FIG. 4 is a flowchart showing example steps that may be performed by the rate reducer agent in an embodiment in which the previous reservation is cancelled and replaced by a new reservation; and

FIG. 5 is a flowchart showing example steps that may be performed by the rate reducer agent in an embodiment in which the existing reservation is edited to reflect a lower price.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

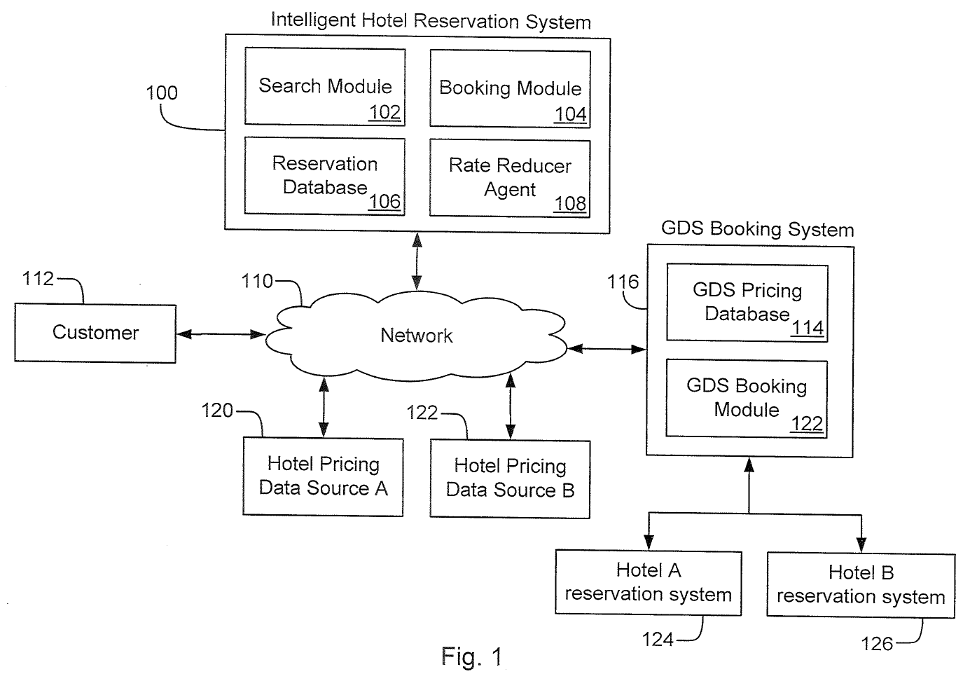

FIG. 1 shows an intelligent hotel reservation system 100 that may be used to search for and book hotel rooms for specified dates. Unlike typical computerized hotel reservation systems, the intelligent hotel reservation system 100 can continue to search for a lower rate after booking and rebook if a lower price for the booked room is found. The term “rebook” encompasses both (1) booking a new reservation and cancelling the previous reservation; and (2) editing a previous reservation to reflect a lower price. This means that a customer need not be concerned about fluctuations in a room's price because the customer's price will be reduced if the room's price becomes lower prior to arrival (or other predetermined time period in which the system searches). The term “hotel” means any entity offering overnight or weekly lodging, including but not limited to hotels, motels, inns, cabins, bed and breakfasts, condominiums, and rental houses. In this example, the intelligent hotel reservation system 100 includes a search module 102, a booking module 104, a reservation database 106, and a rate reducer agent 108.

As should be appreciated by one skilled in the art, the intelligent hotel reservation system 100 may be embodied in many different forms, such as one or more devices, methods, data processing systems, or program products. Accordingly, embodiments of the invention may take the form of an entirely software embodiment or an embodiment combining hardware and software aspects. Furthermore, embodiments of the invention may take the form of a computer program product on a computer-readable storage medium having computer-readable program code embodied in the storage medium. Any suitable storage medium may be utilized, including read-only memory (“ROM”), RAM, DRAM, SDRAM, hard disk, CD-ROMs, DVD-ROMs, any optical storage device, and any magnetic storage device.

Although the intelligent hotel reservation system 100 may be represented by a single computing device in FIG. 1, the operation of the system 100 may be distributed among a plurality of computing devices. For example, it should be appreciated that various subsystems (or portions of subsystems) may operate on different computing devices. In some such embodiments, the various subsystems of the intelligent hotel reservation system 100 may communicate over a network 110.

In the example shown, the network 110 is provided to allow transfer of data between computing devices. The network 110 may be any type of communication scheme that allows computing devices to share and/or transfer data. For example, the network may include fiber optic, wired, and/or wireless communication capability and any of a plurality of protocols, such as TCP/IP, Ethernet, WAP, IEEE 802.11, or any other protocol. The data exchanged over the network may be represented using technologies and/formats including but not limited to the hypertext markup language (“HTML”), the extensible markup language (“XML”), and the simple object access protocol (“SOAP”), etc.

Typically, the intelligent hotel reservation system 100 communicates with one or more computing devices through a shared public infrastructure, such as the Internet. In such embodiments, some or all of the data transmitted over the shared public infrastructure may be encrypted, such as using a secure sockets layer (“SSL”) and/or public key infrastructure (“PKI”) certificate and/or a virtual private network (“VPN”). Those skilled in the art should appreciate that various other security mechanisms can be employed in relation to transmitting data over the network 110.

The intelligent hotel reservation system 100 may include a web page (or other interface) that allows a customer 112 to search room rates of hotels for specified dates using a remote terminal. For example, the customer could access the intelligent hotel reservation system 100 using a web browser over the network 110. The remote terminal used by the customer 112 to access the intelligent hotel reservation system 100 may include, but is not limited to, a desktop computer, a tablet computer, a notebook computer, a personal digital assistant (“PDA”), a cellular phone, and/or a kiosk.

The search module 102 is configured to search one or more hotel pricing and availability data sources with the search criteria received from the customer 112. The hotel price and availability data sources could be available from a variety of different entities over the network 110 or could reside locally with the intelligent hotel reservation system 100. In this example, the search module 102 could search the GDS pricing database 114 of the GDS booking system 116. For example, the search module 102 could search any of the GDS systems known as Sabre, Galileo, Amadeus, or Worldspan. Alternatively (or in addition to the GDS pricing database 114), the search module 102 could search other hotel price and availability data sources. For example, other hotel pricing databases found on the Internet could be searched. For purposes of example only, FIG. 1 shows a Hotel Pricing Data Source A 118 and a Hotel Pricing Data Source B 120 from which the search module 102 could look for hotel rooms meeting the search criteria specified by the customer 112. The search module 102 could be configured to search one or more hotel-related websites, including but not limited to Expedia, Hotels.com, Orbitz, Travelocity, etc. In some embodiments, the search results from one or more of the GDS pricing database 114, Hotel Pricing Data Source A 118, Hotel Pricing Source B 120, and/or hotel-related websites, could be aggregated for the customer 112.

From the search results provided by the search module 102, the customer 112 can book a reservation at a hotel using the booking module 104. The booking module 104 may be configured to prompt the customer 112 to enter the information necessary to book the room, such as the customer's name, contact information, credit card information, etc. This information may be passed to the GDS booking module 122 to book the reservation with the specified hotel. The GDS booking module 122, in turn, schedules the reservation with the specified hotel's internal reservation system, as would be understood by one skilled in the art. For example, if the booking module 104 specified a reservation at hotel A, the GDS booking module 122 would book the room with the Hotel A Reservation System 124. Conversely, if the booking module 104 specified hotel B to the GDS booking module 122, it would schedule a reservation with the Hotel B Reservation System 126. In addition, the booking module 104 could store the information regarding the reservation in the reservation database 106. This allows the information regarding the reservation to be internally stored in the intelligent hotel reservation system 100.

The rate reducer agent 108 may be configured to check for lower prices of the booked room until the arrival date (or other specified time period). As explained below, the customer 112 will be able to take advantage of any reduction in the price of the booked room by automatically creating a new reservation or modifying the existing reservation to reflect the lower price.

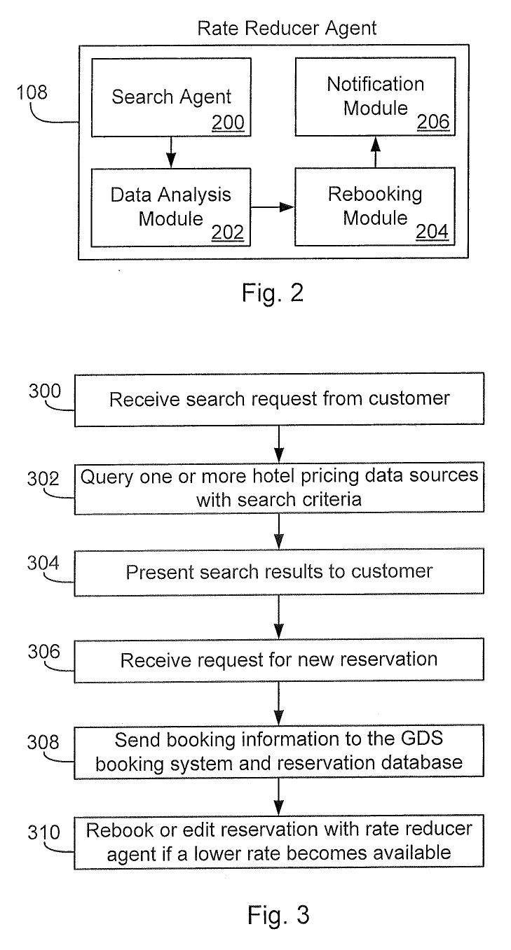

FIG. 2 shows an example embodiment of the rate reducer agent 108. In this example, the rate reducer agent 108 includes a search agent 200, a data analysis module 202, a rebooking module 204, and a notification module 206. The rate reducer agent 108 may communicate with other subsystems of the intelligent hotel reservation system 100 and/or other computing devices on the network 110.

The search agent 200 is configured to search periodically one or more pricing data sources, such as the GDS pricing database 114, for the current price of a previously booked reservation that is stored in the reservation database 106. For example, the search agent 200 may search for the current price of the previously booked hotel room every day or every hour (or other time period). Preferably, the search agent reviews every reservation in the reservation database 106 to determine the current price. Typically, the search agent 200 will continue to periodically search during the potential rebooking period. The potential rebooking period may run from the time of booking until the arrival date, for example. By way of another example, the potential rebooking period could last until some predetermined time prior to the arrival date. For example, the search agent 200 could continue searching until the time when cancellation fees would be incurred for the reservation, which typically occurs around 24 to 48 hours prior to the arrival date.

The search agent 200 provides the current price of the previously booked hotel reservation to the data analysis module 202. The data analysis module 202 compares the current price with the previously booked price. If the current price is lower than the booked price, the data analysis module 202 invokes the rebooking module 204.

The rebooking module 204 is configured to book a new reservation for the lower price found by the search agent 200 and/or edit the reservation to reflect the lower price. For example, the rebooking module 204 could book a new reservation and/or edit the reservation using the GDS booking system 116. Once the new reservation (or edited reservation) has been confirmed, the old reservation is cancelled (if not edited) by the rebooking module 204 (by using the GDS booking system 116, for example). Any changes to the reservation may be stored in the reservation database 106.

The notification module 206 may be configured to notify the customer 112 regarding the savings in the new reservation or updated reservation. It should be appreciated by one skilled in the art that the notification could be communicated to the customer 112 in numerous ways. For example, the customer 112 could be sent an email explaining the savings. By way of another example, a voice mail message could be left for the customer 112.

FIG. 3 is a flowchart showing example steps that may occur during operation of the intelligent hotel reservation system 100. The customer 112 may access the intelligent hotel reservation system 100, such as by accessing a web page provided by the intelligent hotel reservation system 100. The customer 112 will enter search criteria, such as a desired date (or range of dates), type of room, price range, geographic area, hotel amenities, etc. This search request is received by the intelligent hotel reservation system 100, as indicated by step 300. The search module 102 queries one or more hotel pricing data sources, such as the GDS pricing database 114, the Hotel Pricing Data Source A 118, the Hotel Pricing Data Source B 120, and/or hotel-related websites with the search criteria provided by the customer 112, as indicated by step 302. The results of the search found by the search module 102 are then presented to the customer, as indicated by step 304. The customer may then select from the results of the search to book a new reservation, as indicated by step 306. The booking module 104 then sends the booking information to the GDS booking system (or other booking system), which books the reservation with the internal hotel reservation system. Additionally, the booking information is stored in the reservation database 106. (Step 308). After the reservation is booked, the rate reducer agent 108 continues to periodically check whether the booked rate is the lowest price and will rebook the reservation if a lower rate becomes available, as indicated by step 310.

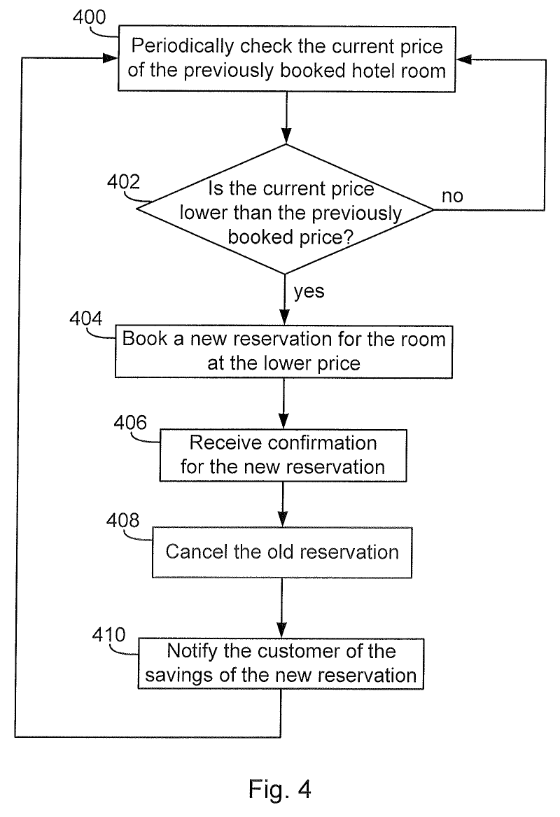

FIG. 4 shows a flowchart with example steps that may be performed by the rate reducer agent 108. In this example, the rate reducer agent 108 periodically checks the current price of a previously booked hotel room, as indicated by step 400. As discussed above, the search agent 200 may check the current price of the booked room from a variety of pricing data sources, such as the GDS pricing database 114, the hotel pricing data source A 118, or the hotel pricing data source B 120. The current price is compared with the previously booked price to determine whether the current price is lower than the previously booked price, as indicated by step 402. If the previously booked price is lower than the current price, the search agent 200 will recheck the price at a later time to see whether the price has been reduced. If the current price is lower than the previously booked price, a new reservation for the room is booked by the rebooking module 204 in the example, as indicated by step 404. Upon booking a new reservation, the rebooking module 204 will receive confirmation, such as a confirmation number, for the new reservation, as indicated by step 406. Upon receiving confirmation of the new reservation, the rebooking module 204 will cancel the old reservation, as indicated by step 408. The notification module 206 will then notify the customer of the savings received and the new reservation, as indicated by step 410. The notification could be given in a number ways, such as an email with the dollar amount of the savings, possibly along with other information such as the new confirmation number. Even if a new reservation has been booked, the search agent 200 will continue to search for a lower price. If a lower price is found, the process will repeat.

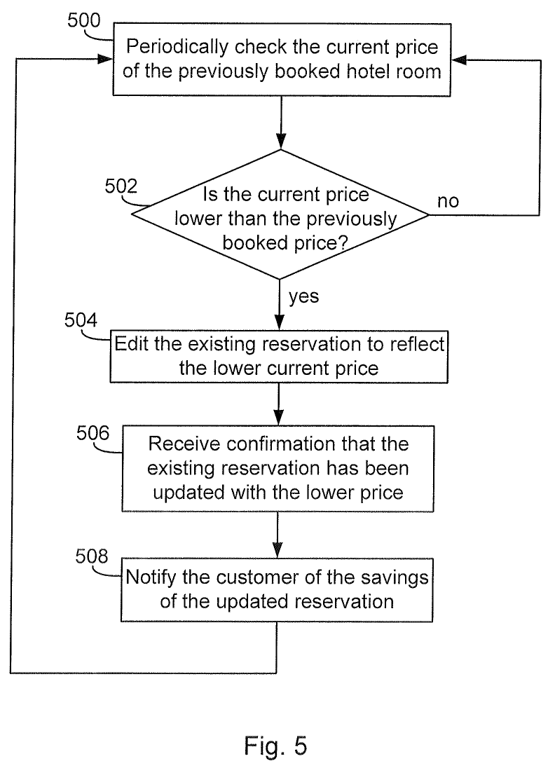

FIG. 5 shows a flowchart of example steps that may be performed by the rate reducer agent in which a previously booked reservation is edited to provide the customer with savings, instead of canceling the previous reservation. In this example, a rate reducer agent 108 periodically checks the current price of the previously booked hotel room, as indicated by step 500. As discussed above, the search agent 200 may retrieve the information about the previously booked room from the reservation database 106 to create a search criteria for determining the current price of the room. The search agent 200 could search a variety of pricing data sources, as discussed above. The data analysis module 202 compares the current price found by the search agent 200 to determine whether the current price is lower than the previously booked price, as indicated by step 502. If the previously booked price is lower than the current price, the search agent 200 will recheck the price at a later time. If the current price is lower than the previously booked price, the rebooking module 204 will edit the existing reservation to reflect the lower price, as indicated by step 504. The rebooking module 204 will receive confirmation that the existing reservation has been updated with the lower price, as indicated by step 506. Upon receiving confirmation that the existing reservation has been successfully edited, the customer will be notified of the savings in the updated reservation, as indicated by step 508.

Although the present disclosure has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A method for booking a hotel reservation, the method comprising the steps of:
providing a reservation database comprising a plurality of hotel reservations, wherein each of the plurality of hotel reservations includes a booked price;
reviewing at least a portion of the plurality of hotel reservations to determine whether a post-reservation price is available that is lower than the booked price; and
rebooking each of the plurality of hotel reservations in which the reviewing step determines that a post-reservation price is available that is lower than the booked price.

2. The method of claim 1, further comprising the step of notifying a respective person associated with each rebooked reservation concerning a savings between the booked price and post-reservation price.

3. The method of claim 1, wherein the reviewing step occurs at predetermined intervals.

4. The method of claim 3, further comprising the step of determining which of the plurality of hotel reservations would incur a penalty if rebooked, wherein the reviewing step skips each hotel reservation that would incur a rebooking penalty.

5. The method of claim 1, wherein the reviewing step includes the step of searching the global distribution system (“GDS”) system for post-reservation prices.

6. The method of claim 1, wherein the reviewing step includes the step of searching one or more hotel pricing data sources on the Internet.

7. The method of claim 1, wherein the rebooking step includes the steps of cancelling an existing reservation and booking a new reservation at the post-reservation price.

8. The method of claim 1, wherein the rebooking step includes the step of editing an existing reservation to change the booking price to the post-reservation price.

9. A method for booking a hotel reservation, the method comprising the steps of:
receiving a request for pricing and availability of one or more hotels for one or more nights from a remote terminal;
querying at least one hotel pricing data source with the request;
presenting search results comprising pricing and availability of the hotels to the remote terminal;
receiving a request for a hotel reservation selected from the search results from the remote terminal, wherein the requested hotel reservation has a booked price;
sending booking information to a booking system for the requested hotel reservation;
receiving confirmation that the requested hotel reservation is booked;
searching for a post-reservation price of the booked hotel reservation subsequent to receiving confirmation that the requested hotel reservation is booked;
rebooking the booked hotel reservation at the post-reservation price if the post-reservation price of the booked hotel reservation is lower than the booked price; and
notifying a person associated with the booked hotel reservation concerning the rebooking responsive to receiving confirmation of the rebooking.

10. The method of claim 9, wherein the rebooking step comprises the steps of:
booking a new reservation at the same hotel as the booked hotel reservation for accommodations that have substantially the same characteristics as the booked hotel reservation at the post-reservation price; and
cancelling the booked hotel reservation responsive to receiving confirmation that the new reservation is booked.

11. The method of claim 9, wherein the rebooking step comprises the step of editing the booked hotel reservation to reflect the post-reservation price.

12. The method of claim 9, wherein the searching step automatically occurs at predetermined intervals after the requested hotel reservation is booked.

13. The method of claim 12, wherein the searching step occurs approximately daily after the requested hotel reservation is booked.

14. The method of claim 12, wherein the searching step occurs multiple times daily after the requested hotel reservation is booked.

15. The method of claim 9, wherein the searching step occurs periodically after the requested hotel reservation is booked until a predetermined time prior to an arrival time associated with the booked hotel reservation.

16. The method of claim 9, wherein the searching step occurs periodically after the requested hotel reservation is booked until approximately when cancellation fees would be incurred for cancelling the booked hotel reservation.

17. The method of claim 16, wherein the searching step periodically occurs until approximately 24-48 hours prior to an arrival time associated with the booked hotel reservation.

18. A method for booking a hotel reservation, the method comprising the steps of:
periodically checking a post-reservation price of a hotel reservation that was booked at a booked price;
comparing the post-reservation price with the booked price;
rebooking the hotel reservation at the post-reservation price if the post-reservation price is lower than the booked price; and
wherein the rebooking step occurs without receiving any communication from a person for whom the hotel reservation is booked.

19. The method of claim 18, wherein the rebooking step comprises the steps of:
booking a new reservation for substantially the same type of accommodations at the same hotel as the hotel reservation at the post-reservation price; and
cancelling the hotel reservation responsive to receiving confirmation that the new reservation is booked.

20. The method of claim 18, wherein the rebooking step comprises the step of editing the hotel reservation to reflect the post-reservation price.

21. The method of claim 18, wherein the checking step automatically occurs at predetermined intervals.

22. The method of claim 21, wherein the checking step periodically occurs until a predetermined time prior to an arrival time associated with the hotel reservation.

23. The method of claim 22, wherein the checking step periodically occurs until a time when cancellation fees would be incurred for cancelling the hotel reservation.

24. The method of claim 18, further comprising the step of notifying a person associated with the hotel reservation concerning the rebooking, wherein the notification includes an amount of savings between the booked price and the post-reservation price.

25. A computer-readable medium having computer-executable instructions for performing a method comprising:
periodically checking a post-reservation price of a hotel reservation that was booked at a booked price;
comparing the post-reservation price with the booked price; and
rebooking the hotel reservation at the post-reservation price if the post-reservation price is lower than the booked price, wherein the rebooking occurs without receiving any communication from a person for whom the hotel reservation is booked.

26. A computerized hotel reservation system comprising:
means for periodically checking a post-reservation price of a hotel reservation that was booked at a booked price;
means for comparing the post-reservation price with the booked price; and
means for rebooking the hotel reservation at the post-reservation price if the post-reservation price is lower than the booked price without receiving any communication from a person for whom the hotel reservation is booked.

27. A computerized hotel reservation system comprising:
a search module configured to provide search results from a hotel pricing data source;
a booking module configured to book a hotel reservation at a booked price selected from the search results provided by the search module;
a rate reducer agent configured to periodically determine whether a post-reservation price for the hotel reservation is lower than the booked price; and
wherein the rate reducer agent is configured to rebook the hotel reservation at the post-reservation price if the post-reservation price is lower than the booked price.

28. The system of claim 27, wherein the rate reducer agent is configured to cancel the hotel reservation responsive to booking a new reservation having substantially the same characteristics as the hotel reservation at the post-reservation price.

29. The system of claim 27, wherein the rate reducer agent is configured to determine whether the post-reservation price is lower than the booked price at predetermined intervals after the booking module books the hotel reservation.

30. The system of claim 29, wherein the rate reducer agent is configured to determine whether the post-reservation price is lower than the booked price approximately daily after the booking module books the hotel reservation.

31. The system of claim 29, wherein the rate reducer agent is configured to determine whether the post-reservation price is lower than the booked price multiple times daily after the booking module books the hotel reservation.

32. The system of claim 27, wherein the rate reducer agent is configured to periodically determine whether the post-reservation price is lower than the booked price after the booking module books the hotel reservation until a predetermined time prior to an arrival time associated with the booked hotel reservation.

33. The system of claim 27, wherein the rate reducer agent is configured to periodically determine whether the post-reservation price is lower than the booked price after the booking module books the hotel reservation until a time when cancellation fees would be incurred for cancelling the booked hotel reservation.

34. The system of claim 33, wherein the rate reducer agent is configured to periodically determine whether the post-reservation price is lower than the booked price after the booking module books the hotel reservation until approximately 24-48 hours prior to an arrival time associated with the booked hotel reservation.
